(19) United States
(12) Patent Application Publication
(10) Pub. No.: US 2008/0118603 A1
(43) Pub. Date: May 22, 2008

(54) NUTRITIONAL BEVERAGE FOR OPTIMAL BONE HEALTH

(76) Inventors: Mark W. LADA, Lake Mary, FL (US); A. Reza Kamarei, Apopka, FL (US); Timothy A. Anglea, Windermere, FL (US)

Correspondence Address: MORRISON & FOERSTER LLP, 1650 TYSONS BOULEVARD, SUITE 400, MCLEAN, VA, 22102, US

(21) Appl. No.: 11/943,139

(22) Filed: Nov. 20, 2007

Related U.S. Application Data
(60) Provisional application No. 60/860,224, filed on Nov. 21, 2006.

(51) Int. Cl. A23L 1/302; A23C 9/123; A23C 9/00; A23G 1/56; A23F 5/00; A23L 2/52; A23F 3/00; A23L 1/20; A23L 2/02; A23L 2/38

(52) U.S. Cl. 426/66; 426/590; 426/583; 426/580; 426/593; 426/594; 426/597; 426/598; 426/599; 426/72

(57) ABSTRACT

A method for enhancing the bone health of a consumer comprising the step of providing the consumer at least about 8 fluid ounces of a nutritional beverage wherein said nutritional beverage comprises at least one beverage base and: a) about 10 to about 60% D.V calcium; b) about 10 to about 60% D.V vitamin D; c) about 10 to about 60% D.V vitamin K; d) about 10 to about 85% D.V. phosphorous; e) about 10 to about 60% D.V magnesium; f) about 10 to about 60% D.V. potassium; g) about 150 to about 600 milligrams food-grade strontium; and h) about 1 to about 10 milligrams food-grade boron.

A regimen for enhancing the bone health of a consumer by consuming at least about 8 fl. ozs. of the nutritional beverage of the present invention at least about two times per day to provide and improve availability of minerals in the body, prevent bone loss, and promote bone growth.

### CROSS REFERENCE TO RELATED APPLICATION

This application claims the benefit of U.S. provisional application Ser. No. 60/860,224, filed Nov. 21, 2006.

### FIELD OF THE INVENTION

The present invention relates to nutritional beverages comprising at least one beverage base in combination with a blend of essential and non-essential vitamins and minerals formulated to promote bone health. The invention may be used to stave off osteoporosis and promote bone formation, as well as bone healing upon fracture.

### BACKGROUND OF THE INVENTION

As explained in a report by the U.S. Surgeon General, bone health is important to the overall health and quality of life of people. See U.S. Department of Health and Human Services. Bone Health and Osteoporosis: A Report of the Surgeon General. Rockville, Md.: U.S. Department of Health and Human Services, Office of the Surgeon General, 2004. According to this report, the bone health of Americans appears to be in jeopardy as each year “an estimated 1.5 million individuals suffer an osteoporosis-related fracture.” Accordingly, a need exists for formulations that optimally promote good bone health.

The benefits of calcium and vitamin D for bone health have been well established. There is growing scientific concern, however, that these nutrients alone are not enough to satisfy the requirements of optimal bone health. Although other supplements have been suggested, research still fails to provide a remedy that accounts for a broad class of consumers and promotes good bone health in every consumer at every age.

Current supplements directed at improving bone health may be found in tablet form. For many consumers, swallowing pills can be undesirable due to the unpleasant taste or after taste. For other consumers, swallowing pills may be altogether impossible. The rate and extent of nutrient bioavailability may also be minimized by the biomechanisms and breakdown of the tablet that has to occur in the body. Furthermore, tablets do not provide the ready-made convenience of a liquid that may ensure a proper regimen and allow for enhanced bone health.

Accordingly, the present invention provides all the needs and advantages for promoting optimal bone health by providing a proper formulation and enhanced remedy for all consumers. Most of all, the present invention addresses appropriate daily intake values that targets specific bone health mechanisms and accounts for the regimen that will allow consumers convenience and an enhanced quality of life.

### SUMMARY OF THE INVENTION

The present invention provides a method for enhancing the bone health of a consumer comprising the step of providing the consumer at least about 8 fluid ounces of a nutritional beverage wherein said nutritional beverage comprises at least one beverage base and: a) about 10 to about 60% D.V calcium; b) about 10 to about 60% D.V vitamin D; c) about 10 to about 60% D.V vitamin K; d) about 10 to about 85% D.V. phosphorous; e) about 10 to about 60% D.V magnesium; f) about 10 to about 60% D.V. potassium; g) about 150 to about 600 milligrams food-grade strontium; and h) about 1 to about 10 milligrams food-grade boron.

The present invention also provides a regimen for enhancing the bone health of a consumer by consuming at least about 8 fluid ounces of the nutritional beverage of the present invention at least about two times per day to provide and improve availability of minerals in the body, prevent bone loss, and promote bone growth.

### DETAILED DESCRIPTION OF THE INVENTION

While the specification concludes with the claims particularly pointing out and distinctly claiming the invention, it is believed that the present invention will be better understood from the following description.

All percentages, parts and ratios are based upon the total daily value of the nutritional beverage of the present invention, unless otherwise specified. All such weights as they pertain to listed ingredients are based on the active level and, therefore, do not include carriers or excipients that may be included in commercially available materials, unless otherwise specified.

The term “daily value” may be denoted as “% D.V.” herein. Except where specific examples of actual measured values are presented, numerical values referred to herein should be considered to be qualified by the word “about”.

As used herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

As used herein, the term “nutritional beverage” refers to the combined formulated beverage that is to be consumed by a consumer in order to promote bone health. The nutritional beverage therefore will include a beverage base and the particularly formulated vitamins and minerals that will contribute to the overall health of bones.

As used herein, the term “beverage base” refers to the type of fluid or liquid that is included in the nutritional beverage. The beverage base of the present invention includes, but is not limited to, pulp and pulp-free citrus and non-citrus fruit juices, fruit drink, vegetable juice, vegetable drink, milk, soy milk, tea, water, sports drink, flavored water, energy drink, coffee, smoothies, yoghurt drinks, hot chocolate and combinations thereof. The beverage base may also be carbonated or non-carbonated.

The term “serving” as used herein refers to 8 fluid ozs. Thus, for example, “5 mg/serving” refers to 5 mg per 8 fluid ozs.

Disclosed is a method focusing on the consumption of nutritional beverages that contain a blend of essential and non-essential vitamins and minerals especially formulated to promote bone health. The invention may be used to stave off osteoporosis and promote bone formation, as well as bone healing upon fracture.

The method of the present invention provides a nutritional beverage specifically formulated to address three of the important bone health mechanisms in the human body. Specifically, the present invention provides a safe level and regimen of nutrients that improve the presence and availability of minerals absorbed by the body; help prevent bone loss; and promote the creation of new bone mass.

The nutritional beverage of the present invention may be consumed as a nutritional supplement beverage such as a “good-for-you” beverage, healthful beverage, sports drink, or refreshment beverage.

### Beverage Base

The nutritional beverage of the present invention comprises at least one beverage base in combination with particular vitamins and minerals that work to enhance the mechanisms of bone health. The beverage base may be comprised of one or more of the following beverage bases provided herein.

The beverage base may be comprised of one or more fruit juices or fruit drinks. Fruit juices may include, but are not limited to, orange juice, grapefruit juice, apple juice, red grape juice, white grape juice, pear juice, concord grape juice, pineapple juice, pomegranate juice, cranberry juice, passion fruit juice, lime juice, lemon juice, mango juice, guava juice, banana juice, red and black currant juice, cashew apple juice, cantaloupe melon juice, apricot juice, blackberry juice, lingonberry juice, dewberry juice, gooseberry juice, crabapple juice, prune juice, plum juice, kiwi juice, strawberry juice, blueberry juice, red raspberry juice, black raspberry juice, cherry juice, watermelon juice, peach juice, nectarine juice, loganberry juice, honeydew melon juice, papaya juice, boysenberry juice, youngberry juice, rhubarb juice, guanabana juice, acai juice, goji juice, fig juice, elderberry juice, date juice, carambola juice, acerola juice, quince juice, bilberry juice, tangerine juice, or any combination thereof. Fruit drinks provide the flavor of any of the aforementioned fruit juices and contain greater than 0% fruit juice but less than 100% fruit juice.

The beverage base may be comprised of one or more vegetable juices or vegetable drinks. Vegetable juices may include, but are not limited to, tomato juice, beet juice, carrot juice, celery juice, or any combination thereof. Vegetable drinks provide the flavor of any of the aforementioned vegetable juices and contain greater than 0% vegetable juice but less than 100% vegetable juice.

The beverage base may be comprised of milk, including but not limited to, whole milk, 2% milk, 1% milk, fat-free milk, or any combination thereof.

The beverage base may be comprised of soy milk, including but not limited to pure soy milk, 4% soy milk, 2%, soy milk, 1% soy milk, fat-free soy milk, any varied fat percent of soy milk, or any combination thereof.

The beverage base may be comprised of tea, including but not limited to green tea, black tea, oolong tea, white tea, red tea, herbal tea, caffeinated tea, decaffeinated tea, hot tea, iced tea or any combination thereof.

The beverage base may be comprised of coffee, including but not limited to regular caffeinated coffee, partially or totally decaffeinated coffee, iced coffee, espresso, cappuccino, latte, and combinations thereof.

The beverage base may be comprised of water, including but not limited to, distilled water, spring water, filtered water, flavored water, and combinations thereof.

The beverage base may be comprised of a carbonated beverage, including but not limited to, colas and sodas.

The beverage base may be comprised of other beverage products such as smoothies, yoghurt drinks, hot chocolate, energy drinks, sports drinks, and combinations thereof.

### Vitamins and Minerals

The nutritional beverage of the present invention provides a method for consuming a safe and effective amount of particular vitamins and minerals essential for the optimal promotion of good bone health whereby consumption improves the presence and availability of minerals absorbed by the body; helps to prevent bone loss; and promotes the creation of new bone mass. If the beverage base already contains a certain vitamin/mineral, additional fortification should take into account the amount of nutrients in the beverage base and thus the nutritional beverage.

The nutritional beverage of the present invention comprises calcium. The calcium source may include, but is not limited to, food-grade tricalcium phosphate, dicalcium phosphate, monocalcium phosphate, milk-derived calcium, calcium lactate, calcium hydroxide, calcium citrate, calcium malate, calcium sulfate, calcium ascorbate, calcium aspartate, calcium glutamate, calcium gluconate, calcium tartrate, calcium succinate, calcium carbonate, microcrystalline hydroxyapatite, calcium fumarate, calcium glycerophosphate, milk calcium, or any combination thereof. The calcium may be included in amounts at least about 10% D.V., at least about 20% D.V., at least about 30% D.V., or at least about 40% D.V. but no more than about 60% D.V., no more than about 50% D.V., no more than about 40% D.V., or no more than about 30% D.V.

The nutritional beverage of the present invention also comprises vitamin D. A source of vitamin D may include food-grade vitamin D3 (cholecalciferol), vitamin D2 (ergocalciferol), or any combination thereof. The vitamin D may be included in amounts at least about 10% D.V., at least about 20% D.V., at least about 30% D.V., or at least about 40% D.V. but no more than about 60% D.V., no more than about 50% D.V., no more than about 40% D.V., or no more than about 30% D.V.

The nutritional beverage of the present invention also comprises vitamin K. A source of vitamin K may include, but is not limited to, food-grade vitamin K1 (phylloquinone). The vitamin K may be included in amounts at least about at least about 10% D.V., at least about 20% D.V., at least about 30% D.V., or at least about 40% D.V. but no more than about 60% D.V., no more than about 50% D.V., no more than about 40% D.V., or no more than about 30% D.V.

The nutritional beverage of the present invention also comprises phosphorus. A source of phosphorus may include, but is not limited to, food-grade calcium phosphates, magnesium phosphates, manganese phosphates, phosphoric acid, or any combination thereof. The phosphorous may be included in amounts at least about 10% D.V., at least about 20% D.V., at least about 30% D.V., or at least about 40% D.V. but no more than about 85% D.V., no more than about 75% D.V., no more than about 65% D.V., or no more than about 55% D.V.

The nutritional beverage of the present invention also comprises magnesium. A source of magnesium may include, but is not limited to, food-grade magnesium oxide, magnesium hydroxide, magnesium phosphate, magnesium glycerophosphate, magnesium glycincate, magnesium malate, magnesium succinate, magnesium fumarate, magnesium ascorbate, magnesium citrate, magnesium sulfate, or any combination thereof. The magnesium may be included in amounts at least about 10% D.V., at least about 20% D.V., at least about 30% D.V., or at least about 40% D.V. but no more than about 60% D.V., no more than about 50% D.V., no more than about 40% D.V., or no more than about 30% D.V.

The nutritional beverage of the present invention also comprises potassium. A source of potassium may include, but is not limited to, food-grade potassium citrate, potassium chloride, potassium phosphate, or any combination thereof. The potassium may be included in amounts at least about 10% D.V., at least about 20% D.V., at least about 30% D.V., or at least about 40% D.V. but no more than about 60% D.V., no more than about 50% D.V., no more than about 40% D.V., or no more than about 30% D.V.

The nutritional beverage of the present invention also comprises food-grade strontium. While enhanced benefits are provided to all, strontium has been demonstrated to increase bone growth and decrease bone fracture rate in post-menopausal women. A source of strontium may include, but is not limited to, food-grade strontium carbonate, strontium lactate, strontium citrate, strontium ralenate, strontium gluconate, or any combination thereof. Strontium may be included in amounts at least about 150 mg/serving, at least about 200 mg/serving, at least about 250 mg/serving or at least about 300 mg/serving but no more than about 600 mg/serving, no more than about 500 mg/serving, no more than about 450 mg/serving or no more than about 400 mg/serving.

The nutritional beverage of the present invention also comprises food-grade boron. Although enhanced benefits are available to all, boron supplementation has been proven to reduce the urinary excretion of calcium, phosphorus, and magnesium while elevating serum concentrations of estrogen and testosterone in post-menopausal women. A source of boron may include, but is not limited to, food-grade sodium tetrahydroborate, boron citrate, boron glycinate, boron aspartate, or any combination thereof. Boron may be included in amounts at least about 1 mg/serving, at least about 1.5 mg/serving, at least about 2 mg/serving or at least about 2.5 mg/serving but no more than about 10 mg/serving, no more than about 6 mg/serving, no more than about 4 mg/serving or no more than about 3.5 mg/serving.

### Additional Ingredients

The nutritional beverage of the present invention may or may not include additional ingredients to promote good bone health. Additional ingredients may enhance the elements and aspects of the present invention while the exclusion of particular ingredients assures the formulation is safe and effective for proper bone health mechanisms to occur.

Therefore, the nutritional beverage of the present invention may comprise vitamin C. A source of vitamin C may include, but is not limited to, food-grade ascorbic acid, potassium ascorbate, calcium ascorbate, magnesium ascorbate, manganese ascorbate, or any combination thereof. When included, vitamin C may be found in the nutritional beverage of the present invention in amounts at least about 10% D.V., at least about 20% D.V., at least about 30% D.V., or at least about 40% D.V. but no more than about 100% D.V., no more than about 75% D.V., no more than about 50% D.V., or no more than about 25% D.V.

The nutritional beverage of the present invention may comprise zinc. A source of zinc may include, but is not limited to, food-grade zinc gluconate, zinc arginate, zinc sulfate, zinc aspartate, zinc oxide, zinc lactate, zinc ascorbate, zinc glycinate, zinc picolinate, zinc citrate, or any combination thereof. When included, zinc may be found in the nutritional beverage of the present invention in amounts at least about 10% D.V., at least about 20% D.V., at least about 30% D.V., or at least about 40% D.V. but no more than about 60% D.V., no more than about 50% D.V., no more than about 40% D.V., or no more than about 30% D.V.

The nutritional beverage of the present invention may comprise manganese. A source of manganese may include, but is not limited to, food-grade manganese sulfate, manganese aspartate, manganese arginate, manganese picolinate, manganese glycinate, or any combination thereof. When included, manganese may be found in the nutritional beverage of the present invention in amounts at least about 10% D.V., at least about 20% D.V., at least about 30% D.V., or at least about 40% D.V. but no more than about 60% D.V., no more than about 50% D.V., no more than about 40% D.V., or no more than about 30% D.V.

The nutritional beverage of the present invention may comprise copper. A source of copper may include, but is not limited to, food-grade copper gluconate, copper hydroxyl carbonate, copper citrate, copper sulfate, copper sebacate, copper lysinate, copper amino acid chelate, or any combination thereof. When included, copper may be found in the nutritional beverage of the present invention in amounts at least about 10% D.V., at least about 20% D.V., at least about 30% D.V., or at least about 40% D.V. but no more than about 60% D.V., no more than about 50% D.V., no more than about 40% D.V., or no more than about 30% D.V.

The nutritional beverage of the present invention may comprise milk basic protein. Milk basic protein, a natural protein found in trace amounts in milk, promotes bone formation while suppressing bone mineral resorption. When included, milk basic protein should be included in amounts at least about 10 mg/serving, at least about 15 mg/serving, at least about 20 mg/serving, or at least about 25 mg/serving but no more than about 600 mg/serving, no more than about 550 mg/serving, no more than about 500 mg/serving or no more than about 450 mg/serving.

The nutritional beverage of the present invention may comprise soy isoflavones (genistein, daidzein and glycitein) to further enhance the promotion of optimal bone health. Soy isoflavones have been proven to increase bone mineral density in post-menopausal women and reduce bone loss. When included, milk basic protein should be included in amounts at least about 6 mg/serving, at least about 8 mg/serving, at least about 100 mg/serving, or at least about 12 mg/serving but no more than about 60 mg/serving, no more than about 55 mg/serving, no more than about 50 mg/serving or no more than about 45 mg/serving.

The nutritional beverage of the present invention may also include absorption enhancers to aid in the absorption of metal cations such as calcium and magnesium. Absorption enhancers included in the present invention may be a dietary fiber. Dietary fibers may include any dietary fiber known in the art shown to enhance calcium absorption or metal cation absorption such as, for example, calcium magnesium. When present, absorption enhancers may be included in amounts at least about 0.2 g/serving, 0.3 g/serving, 0.5 g/serving or 0.7 g/serving but no more than about 9 g/serving, 11 g/serving, 13 g/serving or 15 g/serving.

least about 7.5 mg/serving but no more than about 50 g/serving, no more than about 40 g/serving, no more than about 30 g/serving or no more than about 20 g/serving.

Acidulants, such as citric acid and malic acid, may also be added to the nutritional beverage of the present invention to promote metal cation absorption. When included, acidulants may be found in the nutritional beverage of the present invention in amounts at least about 1 g/L, at least about 1.5 g/L, at least about 2 g/L or at least about 2.5 g/L but no more than about 15 g/L, no more than about 12 g/L, no more than about 10 g/L or no more than about 8 g/L.

The nutritional beverage of the present invention may also comprise processing aids, sweeteners, flavors, emulsifiers, thickeners, or a combination thereof.

It is less desirable for the nutritional beverage of the present invention to comprise vitamin A, iron, vitamin E, thiamin, riboflavin, niacin, vitamin B6, folate, vitamin B12, biotin, pantothenic acid, iodine, selenium, chromium, molybdenum, sodium, or chloride. Iron has been shown to suppress bone remodeling by decreasing osteoblast formation and new bone synthesis.ⁱ Vitamin A has been shown to increase the breakdown of our bones and interfere with vitamin D, thereby inhibiting the absorption of Calcium.ⁱⁱ Vitamin A has also been associated with reduced bone mineral density and osteoporosis with excessive dietary intake.^{iiiiv} ⁱ Weinberg, E. D., Iron-Loading: A Risk for Osteoporosis, Biometals, 2006, 19, 633-635.ⁱⁱ Johannson, S. and Melhus, H., Vitamin A Antagonizes Calcium Response to Vitamin D in Man, J. Bone Miner. Res., 2001, 16, 1899-1905.ⁱⁱⁱ Melhus, et al., Excessive Dietary Intake of Vitamin A is Associated with Reduced Bone Mineral Density and Increased Risk for Hip-Fracture, Ann. Intern Med., 1998, 129, 770-778.^{iv} Genaro Pde S and Martini, L. A., Vitamin A Supplementation and Risk of Skeletal Fracture, Nutr. Rev., 2004, 65, 65-67.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention.

### Example 1

### Orange Juice as the Beverage Base

The ingredients listed in Table #1 were added to 4 liters of orange juice to create an orange juice-based nutritional beverage for optimal bone health. The ingredients were blended into the orange juice for five minutes using a Barinco mixer. This beverage was pasteurized at 177° F. with a 5 second hold time and bottled into 8-ounce sanitized PET bottles at 35° F.

TABLE #1

| | | Nutrient | | | | |
|---|---|---|---|---|---|---|
| | Target | Quantity | Nutrient | Ingredient | | |
| | Nutrient | from Orange | Quantity | Source for | | Ingredient |
| Desirable | Quantity for | Juice in | to be Added | for Desirable | Nutrient | Wt (mg) |
| Nutrient | 240 mL | 240 mL | for 240 mL | Nutrient | Availability in | for 240 mL |
| (units) | Serving | Serving | Serving | (% D.V.) | Ingredient | Serving |
| Calcium (mg) | 350 | 30 | 320 | Milk Calcium | 24.8% | 1290 |
| | | | | Complex | | |
| Vitamin D (IU) | 140 | 0 | 140 | Vitamin D3 Premix | 122 IU/100 mg | 115 |
| Vitamin K (mg) | 0.028 | 0 | 0.028 | Vitamin K | 5.0% | 0.56 |
| Phosphorous | 350 | 30 | 320 | Milk Calcium | 12.5% | 1290 |
| (mg) | | | | Complex | | |
| | | | | (deliver 161 mg of | | |
| | | | | phosphorous) | | |
| | | | | Monopotassium | 22.8% | 2615 |
| | | | | Phosphate | | |
| | | | | (deliver 596 mg of | | |
| | | | | phosphorous) | | |
| Magnesium (mg) | 140 | 28 | 112 | Magnesium | 9.9% | 1131 |
| | | | | Sulfate | | |
| Potassium (mg) | 1225 | 473 | 752 | Monopotassium | 28.8% | 2611 |
| | | | | phosphate | | |
| Strontium (mg) | 375 | 0 | 375 | Strontium | 31.2% | 1202 |
| Boron (mg) | 3 | 0 | 3 | Boron | 1.0% | 300 |

### Example 2

### Apple Juice as the Beverage Base

The ingredients listed in Table #2 were added to 4 liters of clear apple juice to create an apple juice-based nutritional beverage for optimal bone health. The ingredients were blended into the clear apple juice for five minutes using a Barinco mixer. This beverage was pasteurized at 177° F. with a 5 second hold time and bottled into 8-ounce sanitized PET bottles at 35° F.

TABLE #2

| | | Nutrient | | | | |
|---|---|---|---|---|---|---|
| | Target | Quantity | Nutrient | Ingredient | | |
| | Nutrient | from Apple | Quantity | Source for | | Ingredient |
| Desirable | Quantity for | Juice in | to be Added | for Desirable | Nutrient | Wt (mg) |
| Nutrient | 240 mL | 240 mL | for 240 mL | Nutrient | Availability in | for 240 mL |
| (units) | Serving | Serving | Serving | (% D.V.) | Ingredient | Serving |
| Calcium (mg) | 350 | 10 | 340 | Milk Calcium | 24.8% | 1250 |
| | | | | Complex | | |
| Vitamin D (IU) | 140 | 0 | 140 | Vitamin D3 Premix | 122 IU/100 mg | 115 |
| Vitamin K (mg) | 0.028 | 0 | 0.028 | Vitamin K | 5.0% | 0.56 |
| Phosphorous | 350 | 20 | 330 | Milk Calcium | 12.5% | 1250 |
| (mg) | | | | Complex | | |
| | | | | (deliver 171 mg of | | |
| | | | | phosphorous) | | |
| | | | | Monopotassium | 22.8% | 1607 |
| | | | | Phosphate | | |
| | | | | (deliver 366 mg of | | |
| | | | | phosphorus) | | |
| | | | | Dipotassium | 17.8% | 1033 |
| | | | | Phosphate | | |
| | | | | (deliver 183 mg of | | |
| | | | | phosphorus) | | |
| Magnesium (mg) | 140 | 12 | 128 | Magnesium Sulfate | 9.9% | 1293 |
| Potassium (mg) | 613 | 150 | 463 | Monopotassium | 28.8% | 1607 |
| | | | | phosphate | | |
| | 613 | 150 | 463 | Dipotassium | 44.8% | 1033 |
| | | | | phosphate | | |
| Strontium (mg) | 375 | 0 | 375 | Strontium | 31.2% | 1202 |
| Boron (mg) | 3 | 0 | 3 | Boron | 1.0% | 300 |

### Example 3

### Vegetable Juice as the Beverage Base

The ingredients listed in Table #3 were added to 4 liters of V-8™ vegetable juice to create a vegetable juice-based nutritional beverage for optimal bone health. The ingredients were blended into the V-8™ vegetable juice for five minutes using a Barinco mixer. This beverage was pasteurized at 177° F. with a 5 second hold time and bottled into 8-ounce sanitized PET bottles at 35° F.

TABLE #3

| | | Nutrient | | | | |
|---|---|---|---|---|---|---|
| | Target | Quantity | Nutrient | | | |
| | Nutrient | from Vegetable | Quantity | Ingredient | Nutrient | Ingredient |
| Desirable | Quantity for | Juice in | to be Added | Source for | Availability in | Wt (mg) |
| Nutrient | 240 mL | 240 mL | for 240 mL | for Desirable | Ingredient | for 240 mL |
| (units) | Serving | Serving | Serving | Nutrient | (% D.V.) | Serving |
| Calcium (mg) | 350 | 40 | 310 | Milk Calcium | 24.8% | 1371 |
| | | | | Complex | | |
| Vitamin D (IU) | 140 | 0 | 140 | Vitamin D3 Premix | 122 IU/100 mg | 115 |
| Vitamin K (mg) | 0.028 | 0 | 0.028 | Vitamin K | 5.0% | 0.56 |
| Phosphorous | 350 | 0 | 350 | Milk Calcium | 12.5% | 1371 |
| (mg) | | | | Complex | | |
| | | | | (deliver 156 mg of | | |
| | | | | phosphorous) | | |
| | | | | Monopotassium | 22.8% | 2604 |
| | | | | Phosphate | | |
| | | | | (deliver 593 mg of | | |
| | | | | phosphorus) | | |
| Magnesium (mg) | 140 | 0 | 140 | Magnesium Sulfate | 9.9% | 1414 |
| Potassium (mg) | 1225 | 475 | 750 | Monopotassium | 28.8% | 2604 |
| | | | | phosphate | | |
| Strontium (mg) | 375 | 0 | 375 | Strontium | 31.2% | 1202 |
| Boron (mg) | 3 | 0 | 3 | Boron | 1.0% | 300 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40% D.V.” is intended to mean “about 40% D.V.”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for enhancing the bone health of a consumer comprising the step of providing the consumer at least about 8 fluid ounces of a nutritional beverage comprising at least one beverage base and:
a) about 10% to about 60% Daily Value (D.V.) calcium;
b) about 10% to about 60% D.V. vitamin D;
c) about 10% to about 60% D.V. vitamin K;
d) about 10% to about 85% D.V. phosphorous;
e) about 10% to about 60% D.V. magnesium;
f) about 10% to about 60% D.V. potassium;
g) about 150 milligrams to about 600 milligrams food-grade strontium; and
h) about 1 milligrams to about 10 milligrams food-grade boron.

2. The method of claim 1 wherein said consumption is at least about 2 times per day.

3. The method of claim 1 wherein said beverage base is selected from the group consisting of fruit juice, citrus fruit juice, fruit drink, vegetable juice, vegetable drink, milk, soy milk, tea, water, sports drink, flavored water, energy drink, coffee, smoothies, yoghurt drink, hot chocolate and mixtures thereof.

4. The method of claim 1 wherein said nutritional beverage enhances bone health mechanisms comprising the steps of:
a) providing and improving availability of minerals absorbed in the body;
b) preventing bone loss; and
c) promoting the creation of new bone mass.

5. The method of claim 1 wherein said nutritional beverage further comprises an additional ingredient selected from the group consisting of milk basic protein, soy isoflavone, dietary fiber, and mixtures thereof.

6. The method of claim 1 wherein said nutritional beverage further comprises carbohydrates selected from the group consisting of fructose, glucose and mixtures thereof.

7. The method of claim 6 comprising from about 1 g/serving to about 50 g/serving of carbohydrates.

8. The method of claim 1 wherein said nutritional beverage further comprises acidulants.

9. The method of claim 8 comprising from about 1 g/L to about 15 g/L of acidulants.

10. A regimen for enhancing bone health in a consumer comprising the steps of:
a) providing a consumer an 8 fluid oz. serving of a nutritional beverage comprising at least one beverage base and: i) about 10 to about 60% D.V. calcium; ii) about 10 to about 60% D.V. vitamin D; iii) about 10 to about 60% D.V. vitamin K; iv) about 10 to about 85% D.V. phosphorous; v) about 10 to about 60% D.V. magnesium; vi) about 10 to about 60% D.V. potassium; vii) about 150 to about 600 milligrams food-grade strontium; and viii) about 1 to about 10 milligrams food-grade boron; and
b) instructing said consumer to consume said nutritional beverage at least about 2 times per day.

11. The regimen of claim 10 wherein said consumer is instructed to consume said nutritional beverage at least once in the morning and at least once in the evening.
